(19) United States
(12) Patent Application Publication
(10) Pub. No.: US 2011/0015939 A1
(43) Pub. Date: Jan. 20, 2011

(54) SYSTEMS AND METHODS TO CREATE LOG ENTRIES AND SHARE A PATIENT LOG USING OPEN-ENDED ELECTRONIC MESSAGING AND ARTIFICIAL INTELLIGENCE

(76) Inventor: Marcos Lara Gonzalez, New York, NY (US)

Correspondence Address: Marcos Lara Gonzalez, 55 Tiemann Place #29, New York, NY, 10027, US

(21) Appl. No.: 12/839,189

(22) Filed: Jul. 19, 2010

Related U.S. Application Data
(60) Provisional application No. 61/226,530, filed on Jul. 17, 2009.

(51) Int. Cl. G06Q 50/00; G06F 15/16; G06F 17/30; G06Q 10/00

(52) U.S. Cl. 705/2; 709/206; 707/705; 707/755; 707/E17.089; 707/E17.032

(57) ABSTRACT

Provided are systems and methods to create patient log entries using open-ended electronic messaging (e.g. email, text messaging, IM). The systems and methods allow users to update a patient log using widely available communication devices (e.g. cell phones or internet) without the devices needing to have web access and/or to use tailor-made applications. The invention also allows users to update the patient log with limited or no upfront training and describes methods to share the patient data among users using various interfaces. Main system components are: input/output communication interfaces, servers, database, and logic (software) to operate the methods tailored to specific user needs.

### CROSS-REFERENCE TO RELATED APPLICATIONS

The present application claims the benefit of U.S. Provisional Application No. 61/226,530 filed 17 Jul. 2010; which is incorporated herein by reference in its entirety.

### FIELD OF THE INVENTION

The present application relates to systems and methods for creating log entries and sharing a patient log using open-ended electronic messaging and artificial intelligence.

### BACKGROUND OF THE INVENTION

Electronic messaging is becoming a widespread way of communication worldwide. Applications in healthcare are promising, and a new line of research and applications recently suggest that it can be effective in improving show up rates for check ups, immunizations, compliance, and even user monitoring.

A key limitation to using open-ended electronic messaging (e.g. text messaging, email) for monitoring is the fact that the messages are open ended, making it difficult to analyze the incoming information.

One way to overcome this issue is to change the data input interface. For example, a few companies have developed applications that allow users to enter key data to keep a diabetes diary. Two key limitations of these applications are (a) they need to be downloaded (for wireless devices such as cell phones) or have HTML format (for Internet) and (b) for wireless devices, most applications are specific to the brand that they are designed for. Thus, they cannot be universally adopted by, for example, all cell phone users.

Another way to overcome this issue is to ask questions that require very targeted replies (e.g., a text message with reply 1 if yes, 2 if no). A key limitation of this approach is that some data requires multiple pieces of information to have medical value. For example, a user with hemophilia (male inherited condition) may need to report that he had a bleed in his right knee and that he infused 2000 IU.

### SUMMARY OF THE INVENTION

Described herein are 3 novel methodologies and systems that work separately (or combined) to overcome the problems above. In other words, they allow users to create a log with the following advantages:

It can rely solely on the use of open-ended electronic messaging.

It allows users to enter information that requires multiple inputs in a format that is analyzable.

It adapts to the level of sophistication of the user. Untrained users are guided by a decision support model to allow them to report the information they need in one or more messages. Trained users can enter all the information they need faster by using commands and keywords.

It minimizes the number of responses by “understanding” the actions/intentions of the user (for example, set up an alert, enter one log entry, enter multiple log entries). In case of ambiguity, the system can ask the user for feedback or clarification.

It can deliver confirmation message. This allows the user to know that his message has been received. The user can then delete or edit previous input if the confirmation message displays input errors.

It allows users to minimize the amount of information entered by using shortcuts and using defaults established via wireless device or the Internet.

All information collected is stored and can be viewed later using an electronic interface (e.g., online).

In one embodiment, a system is provided for inputting and accessing a patient log by a user, comprising a server capable of sending to, and receiving from the user at least one open-ended electronic message, a database coupled to the server, wherein the database stores the patient log, and a computer program designed to convert the at least one open-ended electronic message from the user into a log entry for the patient log and to manage the patient log. In one or more embodiments the electronic message is a text message (SMS), an email or an instant messaging (IM).

In one embodiment the computer program is further designed to retrieve information for a registered user stored in the database, the database storing information associated with the registered user including contact information for a communications device associated with the registered user, the contact information optionally including a method for contacting the communications device.

In another embodiment the system further comprises a simulator program having at least one of a mobile and an online interface, the simulator program designed to train the user on how to use the system.

In a further embodiment a method is implemented using a processor and a database for inputting and accessing a patient log by a user, the method comprising receiving from the user at least one open-ended electronic message, storing the patient log in the database, converting the at least one open-ended electronic message from the user into a log entry for the patient log using the processor, managing the patient log, and displaying the patient log to the user. In one or more embodiments the method further comprises receiving at least one open-ended electronic message from a communication device associated with the user or the patient log.

In another embodiment, the method further comprises parsing at least one open-ended electronic message by generating at least one token, performing syntax analysis on all tokens to form valid expressions, working out the implications of the expression just validated and taking an appropriate action.

In a further embodiment, the parsing of the at least one open-ended electronic message generates a log entry that includes two or more patient events, wherein each of the two or more patient events is information directly input by the user. In another embodiment the parsing the at least one open-ended electronic message excludes entries that can be generated by only one valid message made of a single user input to generate a log entry.

In yet another embodiment the method excludes entries that can be generated by just only 1 valid message made of a single user input (e.g. word or number) to generate a log entry. In a further embodiment, the method further comprises the use of keywords and or commands by users to report to or manage the patient log.

In another embodiment, predefined keywords or commands relate to the events that the user/s are reporting and/or the action/s that they want to trigger. In an additional embodiment, parsing the message involves using keywords and commands tailored to the type of healthcare data that is being reported to the patient log.

In one or more embodiments, the method provides the capacity to send the user a sequence of messages related to a single log entry with instructions to report such entry. In other embodiments the parsing process requires at least 2 incoming messages and provides instructions to the user on how to report in at least one outgoing system message. In another embodiment, the parsing is done using a vectorial approach or using a neural network. In another embodiment, tokens could be expressed through different combinations of characters (e.g. the inputs saturday and sat could mean the same to the system).

In another embodiment, the action associated to the allowable expression is to update the log or generate a log entry. In a different embodiment the action associated to the allowable expression is sending one or more messages to the communications device requesting additional information or clarification about ambiguities in prior messages. In yet another embodiment, the method further comprises receiving the missing information and using it to complete a valid expression and translating it into an action, the action may include but is not limited to updating of one or more fields in the patient log and/or executing other action/s related to managing such log.

In another embodiment the action associated to the allowable expression is to configure alerts to be sent to the communication device/s associated with the user/s at times determinable by the expression. In yet another embodiment the alerts are meant to prompt the user to perform an action related to managing the log and/or educating the user. In a further embodiment, the alerts are transmitted to the communication device associated with the registered user/s according to the information associated to the said alerts.

In another embodiment, the action associated to the allowable expression is to send one or more confirmation messages to user/s communication devices of certain actions performed by the system, including, but not limited to, updating the log. In yet another embodiment, the action associated to the allowable expression is to set default values for one or more log entries, in case such values are omitted. In a further embodiment, the action associated to the allowable expression is to set default values to trigger actions related to managing the log. In yet a further embodiment, the action associated to the allowable expression is to attach an image or multimedia record to a log entry.

In another embodiment, the method further comprises determining whether a user has alerts set up to prompt the user to perform an action related to managing the log and, based on the outcome, performing a action, including but not limited to sending at least one message to the communications device/s to help the user/s configure alerts related to such actions.

In a further embodiment, the action is to report to the system to generate a log entry. In yet a further embodiment, the action associated to the allowable expression is to provide help to the user. In another embodiment, the action associated to the allowable expression is to provide to view, edit or delete a previous entry. In other embodiments, the action associated to the allowable expression is to consider the rest of the message as a valid string and, without analyzing its content further, storing it in the right field/s of the system database/s.

In an embodiment, the method further includes a simulator program, wherein the simulator program trains the user on how to use the system using a simulator with mobile and/or online interfaces.

In another embodiment, the method has the capacity to query the user regarding administration of medication and/or disease symptoms, send the user reminders with instructions to report, send messages to clarify in case of ambiguity, send confirmation messages after a full entry is made in the log, set default values for a log entry, and allow the user to set up a schedule of reminders. In another embodiment, the log is used for care of a patient having a disease or disorder. In one or more embodiments the disease or disorder is hemophilia. In another embodiment, the log is used for the care of hemophilia patients. In yet another embodiment the disease or disorder is rheumatoid arthritis. In yet a further embodiment the disease or disorder is diabetes, cancer, chronic pain, asthma, erectile dysfunction, heart disease, stroke, an autoimmune disease, transplant rejection, an HIV disease, Parkinson's disease, or Alzheimer's disease.

In another embodiment, the data exchanged relates to administration of medication. In an alternative embodiment the data exchanged relates to wellness, prevention, healthcare education, reinforcement or dietary activities. In a further embodiment the data exchanged relates to disease symptoms.

In another embodiment, the method and system has the capacity to query the user regarding administration of medication and/or disease symptoms. In one embodiment, the service is provided by a third party. In one or more embodiments, the third party is a pharmaceutical company, a managed care organization, a PBM, a pharmacy chain, a disease management company, or a healthcare marketing agency. In another embodiment, the service is provided by a technology firm or by applications developed by a third party compatible with a service offered by the technology firm.

In one embodiment, the system is on a server of the Hospital or healthcare services provider. In another embodiment, an alternative interface to complete and/or access the log and/or perform all actions allowed by such interface. In yet another embodiment, the interface is the Internet, interactive voice response, or a software application compatible with the system.

In one embodiment, the system and method further comprises authenticating users and allowing authorized users to access partial or full log information based on their access privileges. In another embodiment, the system further comprises using a social network invitation scheme, fax, email, or other interfaces accessible by users to confer access rights to the data to other users.

In an additional embodiment, the data is sent to the right user following an order by an authorized user.

In another embodiment connected patient events are structured in a table-like format that allows for a quick information viewing, search and/or filtering.

### BRIEF DESCRIPTION OF THE DRAWINGS

FIG. 1 shows a system diagram according to an embodiment of the present disclosure.

FIG. 2 shows a process for entering information according to an embodiment of the present disclosure.

FIG. 3 shows text messaging log entries and sample messages according to an embodiment of the present disclosure.

FIG. 4 shows alerts according to an embodiment of the present disclosure.

### DETAILED DESCRIPTION OF THE INVENTION

### Definitions

Patient: the individual whose patient events are recorded in the patient log. The patient can be a human or an animal, e.g., a pet or farm animal.

Electronic patient log or patient log: A list of patient events over time that is in electronic format.

Patient event: Any information related to the care of a patient, concerning, but not limited to: Treatment or facets of treatment, prevention, wellness, safety, use of healthcare devices, sports training, and/or comprehension of healthcare information.

User: Any individual/s (e.g., a human patient, caregiver, pet owner, healthcare provider) who can send information remotely from an input device to the central system and/or access the patient log partially or fully. The term “input user” may be used for users who provide input to the system and “access user” may be used for users who access the system. Input and access users can overlap and/or be the exact same user/s.

Communication device: Any electronic device, including but not limited to computers and wireless devices, where the user sends information to and/or receives information from a remote system. In some instances, a communication device may be treated by the system as a proxy for user/s (i.e., an action performed utilizing a device owned by one or more users could be considered an action requested directly by such user/s).

System: Combination of software and hardware needed to exchange information with the users, including, but not limited to exchange of electronic messages according to a predefined logic, and displaying information derived from these messages. Examples of system components include: a server, database, a network, including, for example, a LAN, WAN, Internet, mobile network, telecommunication network, satellite network, etc., incoming and outgoing messaging interfaces, messaging devices, such as, for example, PDAs, portable computers, cell phones, wireless devices, and mobile devices, and the logic (code) to operate the invention.

Patient log entry: An update in an electronic patient log requiring at least one user input and internal processing by the system, usually to record a patient event, valid combination of events, or action.

Open-ended electronic messaging: Messaging using an input device where the minimal functionality required by such device is to freely type a sequence of characters (valid and invalid) and to send it to a System. For example, text messaging, email or instant messaging (IM) are considered open-ended electronic messaging in this definition. Filling an online formulary or a list of application input fields is not considered open-ended electronic messaging, unless such inputs fields are all open-ended. Many current devices (e.g., computer) have both open-ended (email) and non-open ended (browser) electronic communication capabilities.

### Part A—Systems and Methods for Collecting Information

The systems and methods described herein are applicable to a wide range of healthcare and self-management needs where the user is required to log events. For any particular healthcare or self-management need, the specific actions to be performed, information collected, and interfaces described below need only be tailored to the specific purpose or patient event/s for which it is to be adapted. For example: A patient with metabolism disorders may use the systems and methods to log data about type of food eaten, exercise, calories, insulin levels, cholesterol levels, and drug adherence. Alternatively, a patient with hemophilia may need to collect information about factor infused, reason for infusion and/or bleed location using the same methods.

The invention can be applied to virtually any chronic and acute condition that requires logging of patient events, including but not limited to: hemophilia, rheumatoid arthritis, hepatitis C, diabetes, cancer, migraine, other chronic pain, asthma, erectile dysfunction, autoimmune diseases, transplant rejection, aids, Parkinson, Alzheimer, stroke care, etc.

Therapeutic categories and/or drugs to treat them may include, but are not limited to: antihyperlipidemics, contraceptives, gastrointestinals, antidepressants, antidiabetics, antiasthmatics, antihypertensives, anticonvulsants, hypnotics, antibiotics, antiinflammatories, immunosupresors, cancer-fighting agents, hormones, blood derivatives, anticoagulants, antivirals (e.g. HIV, Hepatitis C), etc.

When used for treatment, uses include, but are not limited to: Monitoring medication adherence, safety, side effects for a drug and/or disease progression. It can also be used for wellness, physical training, or prevention. Healthcare providers should be considered in the wide sense, including but not limited to doctor, nurse, dietician, physical trainer, dentist, chiropractic, psychologist, or any one who is involved in the patient care, including the parent of a minor when appropriate.

As used herein, providing the capability for using these systems does not require providing the computer interface or web portal used for storage of data or online communication with the users.

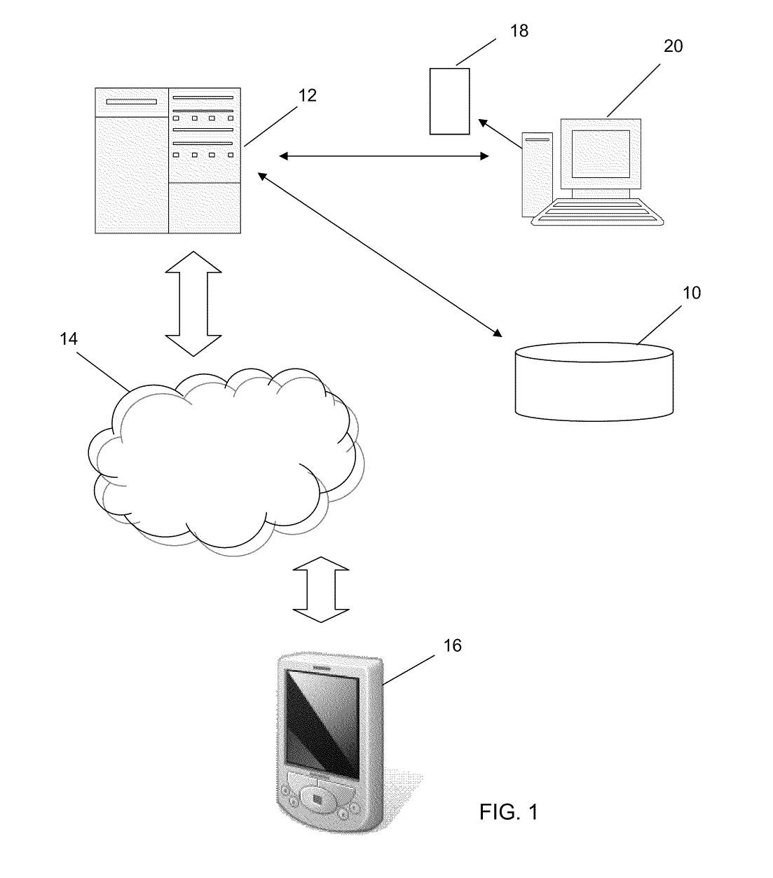

One example of a system is shown in FIG. 1, wherein a database 10 is coupled to a server 12 which is coupled to a wireless network 14, such as, for example, a mobile network. A user mobile device 16 transmits to and receives messages via the server 12 through the mobile network 14. The messages are used to update or modify the information stored in the database 10. The system functionality is managed and controlled by a software program 18 resident on the server 12 or on a computer 20 coupled to the server 12 and the database 10. The software program 18 controls the methods described below and the processing of the data by the computer 20 and storage of the data in the database 10.

As shown below, an example of a system and three methods are provided for creating a complex user log via open messages (such methods could be integrated in one “super system-method” that comprises a combination of the three; in this case they will be considered sub-systems-methods).

### Method 1—Wizard Mode

This mode guides users with no prior knowledge of the system's internal logic to provide the answers needed to create the log.

The wizard mode's logic (embodied in software), is able to trigger a logic and interactive exchange of messages both at predefined times or, in response to a user-initiated message.

Though the method is applicable to a wide range of medical needs, the specific actions performed and information collected using the wizard mode will be tailored to the specific purpose for which it is designed.

### Example for Hemophilia:

As part of regular care, most hemophiliacs should keep a log to report their factor infusions, possibly reporting some of the following: (a) the number of factor units they infuse, (b) the cause of infusion, and, in case of bleed (c) location (if any), (d) infusion time, (e) product used, (f) lot number.

In the case of an infusion log for hemophilia care, the wizard could perform actions, including, but not limited to:

A. Send the user (e.g. user/caregiver) reminders with instructions to report

B. Collect information to create the infusion log

C. Send messages to clarify in case of ambiguity

D. Send confirmation messages after a full entry is made in the infusion log table (i.e. the system accepts the input as valid entry)

E. Set default values for infusion reporting, such as product, or time.

F. Allow the user to set up a schedule of reminders via wireless message

(can also be done online)

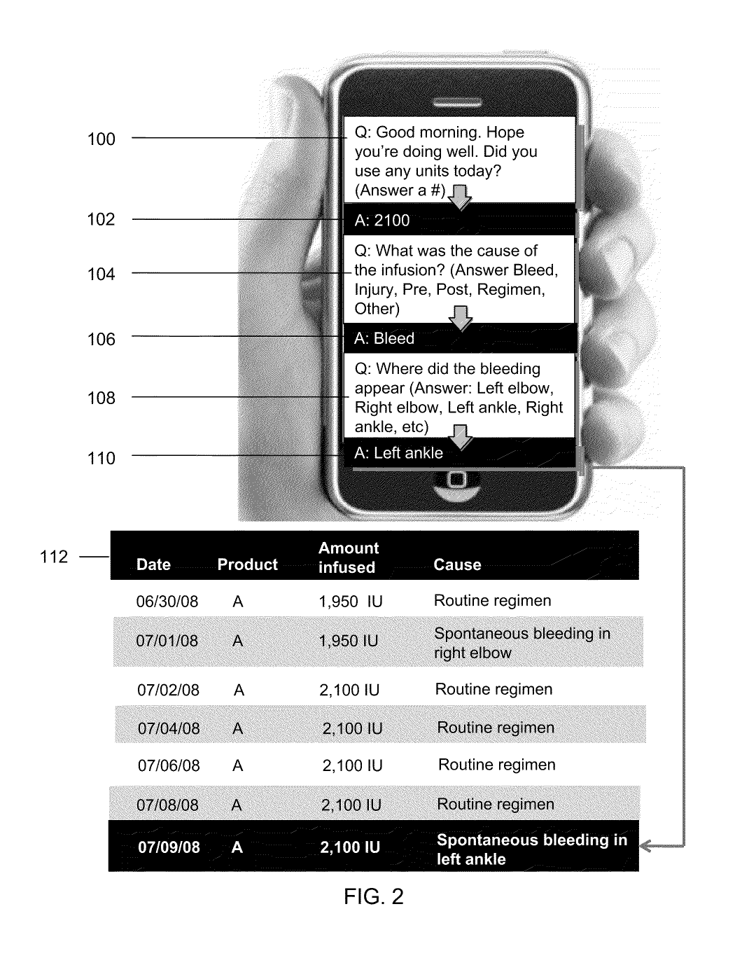

Hemophilia Sub example (1) to illustrate actions A, B C, D assuming the user already has an infusion schedule. As shown in FIG. 2, the user could receive the following flow of messages on the days he infuses:

As depicted in step 100, the system sends a question asking the user if he has used any units today: “Good morning, did you use any units today? Please answer with #”. In step 102 of the example, the user replies 2100. If the user replies a valid format (e.g., a number higher than 10 and smaller than 100000), he will receive a second message, in step 104, asking for the reason of the infusion: “What is the reason for infusion: 1. Prophylaxis; 2 Bleed; 3. Injury; 4. Pre; 5. Post. Please reply with a number.” If the user reports a valid entry (1-5), the system will determine whether to send a confirmation message, or an additional message. In this example, the user responds, in step 106, with “Bleed.” For responses “2” or “3” (bleed/injury), the user will receive an additional message, step 108, asking: “where did the bleeding appear?” The user replies, in step 110, “left ankle.”

At each step the system has validated that the response received is valid. If it is not valid, it can send a reply message to clarify. For example, if the person replies that the bleed happened in the “loft ankle”, the system can reply: “did you mean left ankle? Reply 1 if yes, 2 if no.” The system can provide tips on valid formats and help options.

At the end of the process, as shown in step 112, the user will receive a confirmation message summarizing all the information collected. For example: “Successful entry on Jul. 9, 2008. Units: 2100; product: A; cause: bleed; location: left ankle. To edit or delete: type “edit last” or “delete last”.

Hemophilia Sub example (2) to illustrate actions A, B, C, D, assuming the user already does not have an infusion schedule. The user could receive the following flow of messages on a predetermined day of the week. The user receives a question asking him in which days, if any, he has infused in the last week. For each day reported the user will receive message/s asking for the number of units he infused on these days. If user replies with a valid number/s of units a second message will be sent asking for the reason of infusion. If the user reports a bleed, he will receive an additional message asking for the body part and side where the bleed was located. At the end of the process, the user will receive confirmation message/s summarizing all the information collected.

### User-Initiated Wizard:

The wizard mode can also be triggered by guessing user-initiated messages. For example, if the user sends a message with the content “2000”, the system can be trained to guess this is probably a “log entry action” of “2000” units. In response to this, the system could reply: “OK, you infused 2000 units, what is the reason for infusion? a. prophy; b. bleed . . . y. None of the above, please disregard my previous message”

### Timeouts:

If messages are not linkable to their response (e.g. case of text messages), the wizard may have defined time intervals, after which, if no response is received, future responses will not be considered part of a previous “conversation”. For example, if the person replies 2000, and 3 days later, prophylaxis, the system may disregards both messages because the time span is too long to consider them as belonging to the same log entry conversation.

### Hemophilia Subexample to Illustrate Default Values (Applicable to all Log Methods):

Defaults are created to avoid entering data that has always the same value. For example, by default, the value for infusion date/time equals the time at which the message is sent, unless this content is defined in the message.

The product used can be made to provide a default in three ways: 1) Set up as default online; 2) repeated reporting, assuming a user reports using product A a few times. The system's logic could then trigger a response such as: “do you want product A as default? Please reply 1 if yes 2 if no. If the user replies 1, all future infusion entries will have the value product=A; except otherwise stated in the message; or 3) default command, this functionality, part of the shortcut mode, allows a command to set up default values. For example: command name=[default] value=[product A].

### Infusion or Content Alerts:

The user will be able to set up alerts to remind him/her of reporting or to receive content of interest. These alerts can be set using the wizard or the shortcut modes.

### Set Up Alerts Using the Wizard Mode:

Users receive a message inviting them to set up infusion alerts. If the answer to the previous question is YES, the user will receive a second message asking him to introduce the days and time when he wants to receive the alerts. After sending a valid message with the schedule information, the user will receive a confirmation message with his new alerts schedule. It will also include info about how to change it online.

### Method 2—Shortcut Mode

The shortcut or advanced mode, as opposed to the wizard mode, requires some knowledge of the system's keywords and commands. Thus, it may not be as intuitive to new users.

An advantage is that it allows users to create a full log entry (e.g. to report number of units, reason of infusion, body part and side) or execute an action (e.g. to set up alerts) with fewer messages (in most cases, just one).

Another advantage is that the wizard and shortcut methods can work together. So, in some embodiments, if the response to how many units you used is incomplete, the wizard mode is triggered. If the minimal information to create a log entry or perform an action is contained in the message, the shortcut logic will do the processing. This implies that both methods can share some common logic that decides which method is more appropriate to interact with the user based on user feedback.

It is anticipated that most users will start with the wizard mode and switch to the shortcut mode as soon as they familiarize with it because it is a quicker/more convenient way to report.

### Infusion Log Entry:

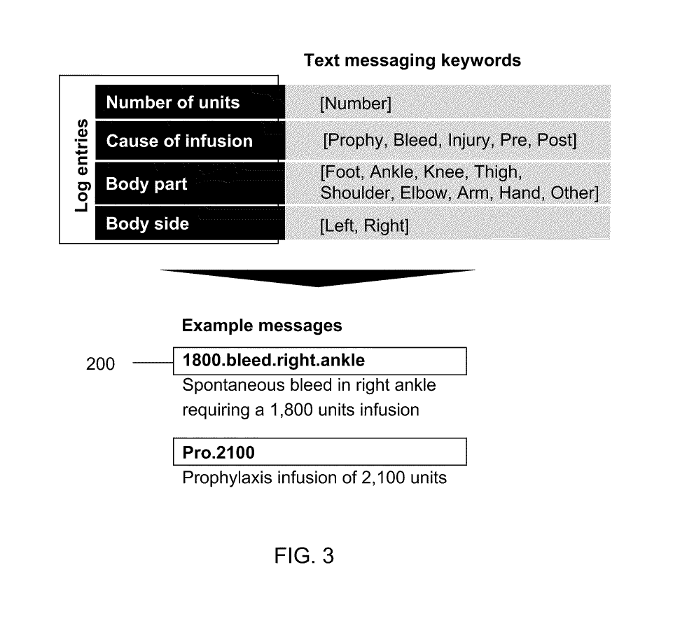

FIG. 3 summarizes one of the many subsets of syntax that could be used for reporting a product infusion and provides examples of how to use them. Using the syntax shown in step 200, reporting a bleed of 1800 units in the right ankle would be: 1800 bleed right ankle.

### Abbreviations:

For user convenience, keywords and commands can be abbreviated according to a predefined logic. Thus, “1800 bleed right ankle”, could be written by the user as “1800 ble rig ank” or possibly “1800 bl ri an”. Abbreviations are dependent on the number of keywords and their similarity.

### Defaults:

As in the wizard mode, the user is able to set up the default values for inputs that are usually the same, such as the product. Defaults can be set using a command (e.g. [default]) or using the same logic than with the wizard mode. Example 1: User: “default [BrandA]”, System: Brand A will be set as the default product. Each log entry will add the field [Brand A] to the rest of the entry.

### Create Infusion or Content Alerts:

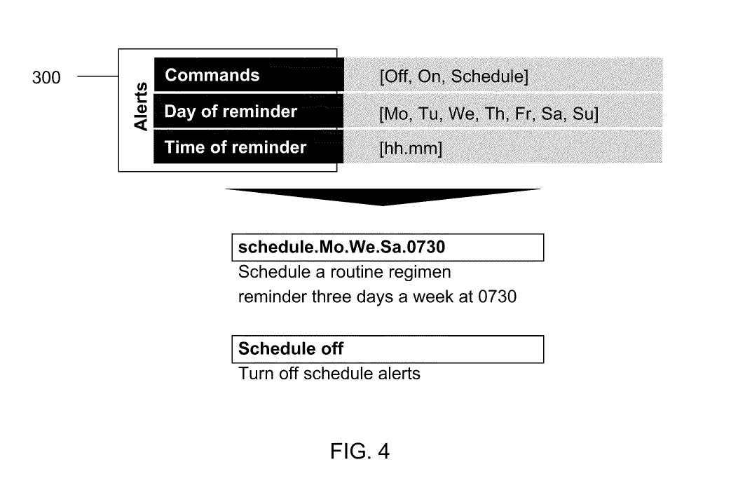

As shown in FIG. 4, the user will be able to set up alerts 300 to remind him/her of reporting or to receive content of interest. These alerts can be set using the wizard or the shortcut modes. Users can proactively create, activate or deactivate the infusion alerts and modify their infusion schedule using the compact syntax. As shown in FIG. 4, the syntax is described and examples of how to use it are provided:

For alternate days, the user can use the commands [EVERY] and [START]. For example [EVERY] 2 days [START] today. Time could be expressed in agreed formats (am/pm, 0-24, etc.) and time zones.

### Additional Commands:

Depending on the type of logs, additional commands can be created to manage the reporting needs of the user. For example, the user will be able to display, edit and delete entries from their device through the use of commands entry, edit and delete. If the user sends the system the message: “entry 25”, the system can reply with a message showing the content of entry 25. If the user sends to the system the message: “delete 25”, the system could delete this entry from the infusion log. The user can CC another person (e.g., a caregiver by sending the system a command such as “CC” and the number of this person). Notes (or free texting) can be introduced after a free texting command such as “NOTES” command (e.g. [NOTES] I fell off my bike).

### Images:

The user can attach images to the text (e.g. a photo of injuries). In the case of text messaging, a command can be used to refer them to a particular entry (e.g., [ENTRY] 1).

### Help Function:

The system can provide general help and command specific help to the user's phone. If the user texts the word ‘help’, he will receive a message such as “Please reply a # to get help with: 1=Reporting prophy, pre, post, 2=Reporting a bleed, 3=Managing infusion alerts, 4=Advanced commands”. Sending a message with the word ‘help’ followed by a ‘command’ will provide information about this particular command and examples of utilization. If the user sends a message to the system such as: “help product” the system could reply with instructions “Type [default] followed by your product name and this will be used to fill your log automatically such as default product A.

The system also provides tips to the users to train them on how to use the system better.

### Error Handling:

A smart processor will handle errors associated with invalid or incomplete user messages. If the user enters an invalid answer, he will receive a message asking for clarification. Example 1: User: “sche Mo Tr 8p”, System: “Did you mean Tuesday or Thursday?” Example 2: User: “bleed 2000 re kn”, System: “Did you mean your right or left knee?”

If the user enters a message that is incomplete, he will receive a message asking for the missing information. Example 1: User: “bleed left arm”, System: “How many units did you infuse?” Example 2: User: “sch Mo Tu Fr”, System: “What time do you want to receive the alerts?”

### Interactive Training:

Users can be trained to use the shortcut using a log reporting simulator.

For example: “try to report a prophylaxis of 2000 units”. Users can also use an online interface that simulates the wireless device.

### Method 3—Information Extraction Using Natural Language Processing

The system receives free text inputs and analyzes it using a natural language processing to perform the following subtasks:

Named Entity Recognition: recognition of entity names relevant to the log.

Coreference: identification chains of noun phrases that refer to the same object. For example, anaphora is a type of coreference.

Terminology extraction: finding the relevant terms for a given corpus.

Relationship Extraction: identification of relations between entities, such as bleed happens at body part(s) (extracted from the sentence “I had a bleed in my ankle.”) or product has certain lot number (extracted from the sentence “product lot number is 456789.”)

The system can be trained and optimized to recognize this inputs using artificial intelligence, such as neural networks.

### EXAMPLE I

### Terminology and Relationship Extraction (Vectorial Approach Applied to Populate a User Log)

Vectorial approach: Given s arrays (A1, . . . , As) where n, is the length of array Aᵢ, whose elements are strings of characters, let R be a square matrix of dimensions

$${\sum }_{i}^{s} {n}_{i} \times {\sum }_{i}^{s} {n}_{i}$$

that defines relations between the different elements of the s arrays. All elements from a given array are conceptually similar. For example they could be valid values of a characteristic related to the event that the user wants to report.

The relations are defined for all possible pairs created with the elements in the s arrays. Therefore, the element in row i and column j of matrix R, Rᵢⱼ, is defined as the relation between the elements of the pair (Akₚ, Al_{q}) such that

$$i = {\sum }_{c = 0}^{k - 1} {n}_{c} + p , j = {\sum }_{c = 0}^{l - 1} {n}_{c} + q , where {n}_{0} = 0.$$

In these examples, we only consider three possible types of relations: 1 (necessary relation between the two elements), 0 (no relation between the two elements) and −1 (incompatible relation between the two elements).

The algorithm will filter the information given in a message in the following way. It will break the message into strings or characters separated by a space, dot, comma or colon, that we will call pseudo words. The algorithm will only recognize or filter those pseudo words that match any of the elements of the predefined arrays. Every pseudo word can only be associated to a single element of an array. In case of ambiguity, the system will associate it to the one with the higher number of common characters.

### Subexample 1

Filtering of different text sequences reported by users with hemophilia:

Array 1: (bleed, bl, profilaxis, pro)

Array 2: (hand, ha, foot, ft)

Array 3: (right, rg, left, lft)

$$pro \text{-}$$

$$bleed bl filaxis pro hand ha foot ft right rg left lft$$

$$Matrix R : \begin{matrix}bleed \\ bl \\ profilaxis \\ pro \\ hand \\ ha \\ foot \\ ft \\ right \\ rg \\ left \\ lft\end{matrix} ( \begin{matrix}- 1 & - 1 & - 1 & - 1 & 1 & 1 & 1 & 1 & 0 & 0 & 0 & 0 \\ - 1 & - 1 & - 1 & - 1 & 1 & 1 & 1 & 1 & 0 & 0 & 0 & 0 \\ - 1 & - 1 & - 1 & - 1 & - 1 & - 1 & - 1 & - 1 & - 1 & - 1 & - 1 & - 1 \\ - 1 & - 1 & - 1 & - 1 & - 1 & - 1 & - 1 & - 1 & - 1 & - 1 & - 1 & - 1 \\ 1 & 1 & - 1 & - 1 & - 1 & - 1 & - 1 & - 1 & 1 & 1 & 1 & 1 \\ 1 & 1 & - 1 & - 1 & - 1 & - 1 & - 1 & - 1 & 1 & 1 & 1 & 1 \\ 1 & 1 & - 1 & - 1 & - 1 & - 1 & - 1 & - 1 & 1 & 1 & 1 & 1 \\ 1 & 1 & - 1 & - 1 & - 1 & - 1 & - 1 & - 1 & 1 & 1 & 1 & 1 \\ 0 & 0 & - 1 & - 1 & 1 & 1 & 1 & 1 & - 1 & - 1 & - 1 & - 1 \\ 0 & 0 & - 1 & - 1 & 1 & 1 & 1 & 1 & - 1 & - 1 & - 1 & - 1 \\ 0 & 0 & - 1 & - 1 & 1 & 1 & 1 & 1 & - 1 & - 1 & - 1 & - 1 \\ 0 & 0 & - 1 & - 1 & 1 & 1 & 1 & 1 & - 1 & - 1 & - 1 & - 1\end{matrix} )$$

Sequence 1—“I had a bleed in my right hand when I fell from my bicycle”. The system would identify: ‘bleed’ from array one, ‘hand’ from second array and ‘right’ from the third one. The relations between ‘hand’ and ‘right’ and between ‘bleed’ and ‘hand’ according to matrix R are set to 1, therefore this text would create a successful entry of a bleed in the right hand.

Sequence 2: “bl rg ha”. The system would identify: ‘bl’ from array one, ‘ha’ from the second array and ‘rg’ from the third one. The relations between the pairs of these three elements according to matrix R are 1, therefore this text would create a successful entry of a bleed in the right hand.

Sequence 3: pro bl lf blood. The system would identify: ‘bl’ and ‘pro’ from array one. The relation between the elements of this pair according to matrix R is −1, therefore the system would provide an error message for entering two incompatible pseudo words.

Sequence 4: ha lf mmmmm asdfa bl ppt foot. The system would identify: ‘bl’ from array 1, ‘foot’ from array 2 and ‘If’ from the third one. According to matrix R, none of the relations between the pairs of these three elements is −1, therefore this would create a successful entry of a bleed in the left foot.

### Example 2

### Terminology and Relationship Extraction (Neural Networks)

Neural networks are powerful tools for the identification of patterns. This example also covers its application for the recognition/extraction of information from the natural language contained in an open-ended electronic message. This extracted information will be used to populate the fields of a user log.

The process starts by filtering the strings of characters contained in the message and codifying them into series of numbers. The algorithm then associates each text input to a cluster. A cluster is defined by the meaning of the filtered expression. This technique is useful only in the case in which the type of messages that the user can send are limited and can be classified in different clusters by meaning. Each cluster is specific enough as to create a univocal entry in the user log. Examples of clusters are ‘spontaneous bleed in right hand,’ ‘injury bleed in left ankle,’ etc.

This embodiment of the system is based on a preceptor multilayer structure that adapts to the complexity of the messages and the number of clusters to identify. The typical structure could be of an input and output layer and an additional hidden one, even though for highly complex messages, a structure of more than one hidden layer may be needed.

The adjustment of the parameters in the neurons is accomplished based on a supervised learning. The data is divided in two groups: a learning group and a training group. The adjustment of the parameters in the neurons is accomplished with the learning group to minimize the error in the clustering of the messages and the optimal group is based on the results with the training group in order to avoid overtraining/learning of the network.

The operational tool is able to classify different text sequences in different clusters based on the output of the neural network. The cluster is then used to complete the information of an entry to a log.

### Example of Processing a Text Message to Populate a Hemophilia Log:

The user sends a message: “I had a bleed on my left ankle and I infused 2000 units because I fell from my bike”. The processor filters everything but the numbers: “I had a bleed on my left ankle and I infused units because I fell from my bike”. The neural network, according to the learning and training processes classifies this sequence of text into the cluster “injury bleed in left ankle”. The information in the cluster is then used to complete the log entry. At the end of this process the following entry is created in the user log: reason of infusion=bleed; cause of bleed=injury; units infused=2000, body part=ankle; body side=left; time of infusion=time stamp.

### Complementary Input Interfaces:

Each of the 3 methods (or combination of methods) may be integrated into a system with complementary input interfaces, such as a web portal, Interactive voice response, or a software application. One user may utilize different interfaces depending on the input device/s available at the time and different authorized users may use different devices to create log entries.

Part B —Methods for Sharing Log Information (can be Used with Part A but not Required)

In one embodiment, all the information contained in the wireless message is stored in a database, where a matrix of n dimensions is created with the incoming inputs. This information is displayable in electronic format (e.g. an online log) to authorized users. The log information may be part of a larger user portal, where other healthcare or user information is stored, or integrated with such portal. Thus the access/sharing actions described involve information, including, but not limited to, all log information a user is authorized to access and/or share.

### Standard Invitations:

Users with sharing privileges can invite other users to view this information. In one embodiment, users may give or receive invitations to a group of people with certain access privileges using, for example, a social networking invitation scheme. Users can search other users, and invite them to share a certain degree of information. In another embodiment, multiple individuals may having access rights to the log or data repository where the log is located. For example, having a hospital doctor granted access to an EMR where the log data is available.

### One-Time Sharing:

Users with sharing privileges (e.g. user, caregiver) can also send the log (or a report view) to an authorized user (e.g. healthcare provider) via fax or email, mail, or appropriate format.

The user can send an order to send the report using a wireless device: for example: calling/texting a number with a keyword or PIN (note: this is a standalone invention that enhances reporting of info), or using an online profile to deliver the log (or appropriate report).

In some embodiments, when the system cannot authenticate the user, the “send report” feature will be enabled provided that the non-authenticated user enters a valid code for the user's clinic. In addition, the clinic will need to have been previously authorized to receive reports from this particular user. For example, if a user calls to a 1-800 number and enters a valid clinic identifier, the report will only be sent out if the clinic was previously authorized by the user to receive it (e.g. via online settings). Authenticated users (e.g. online or using PINs), may send the report at any time to any clinic.

In view of the above, it will be seen that the several advantages of the invention are achieved and other advantages attained. As various changes could be made in the above methods and compositions without departing from the scope of the invention, it is intended that all matter contained in the above description and shown in the accompanying drawings shall be interpreted as illustrative and not in a limiting sense.

Embodiments involving computer software and hardware generally execute algorithms which implement method embodiments. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared and otherwise manipulated. It has proven convenient at times, principally for reasons of common usage, to refer to these signals as bits, values, data, elements, symbols, characters, terms, numbers or the like. It should be borne in mind, however, that all of these and similar terms are to be associated with the appropriate physical quantities and are merely convenient labels applied to these quantities. Unless specifically stated otherwise, it will be appreciated that throughout the present disclosure, use of terms such as “processing”, “computing”, “calculating”, “determining”, “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Various embodiments may be implemented with the aid of computer-implemented processes or methods (a.k.a. programs or routines) that may be rendered in any computer language including, without limitation, C#, C/C++, Fortran, COBOL, PASCAL, assembly language, markup languages (e.g., HTML, SGML, XML, VoXML), and the like, as well as object-oriented environments such as the Common Object Request Broker Architecture (CORBA), Java™ and the like. In general, however, all of the aforementioned terms as used herein are meant to encompass any series of logical steps performed in a sequence to accomplish a given purpose.

Embodiments may be implemented with apparatus to perform the operations described herein. This apparatus may be specially constructed for the required purposes, or may comprise a general-purpose computer, selectively activated or reconfigured by a computer program stored in the computer. Such a computer program may be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, flash memory, magnetic or optical cards, or any type of media suitable for storing electronic instructions, and each coupled to a computer system bus.

One of ordinary skill in the art will immediately appreciate that the teachings of the present disclosure may be practiced with computer system configurations other than those described above, including hand-held devices, mobile devices, multiprocessor systems, microprocessor-based or programmable consumer electronics, DSP devices, network PCs, minicomputers, mainframe computers, and the like, as well as in distributed computing environments where tasks are performed by remote processing devices that are linked through a communications network.

Other embodiments within the scope of the claims herein will be apparent to one skilled in the art from consideration of the specification or practice of the invention as disclosed herein. It is intended that the specification be considered exemplary only, with the scope and spirit of the invention being indicated by the claims.

In view of the above, it will be seen that the several advantages of the invention are achieved and other advantages attained.

As various changes could be made in the above methods, systems and devices without departing from the scope of the invention, it is intended that all matter contained in the above description and shown in the accompanying drawings shall be interpreted as illustrative and not in a limiting sense.

1. A system for inputting and accessing a patient log by a user, the system comprising:
a server capable of sending to, and receiving from the user at least one open-ended electronic message;
a database coupled to the server, wherein the database stores the patient log; and
a computer program designed to convert the at least one open-ended electronic message from the user into a log entry for the patient log and to manage the patient log.

2. The system of claim 1, wherein the at least one open-ended electronic message is at least one of a text message (SMS), an email and an instant message (IM).

3. The system of claim 1, wherein the computer program is further designed to retrieve information for a registered user stored in the database, the database storing information associated with the registered user including contact information for at least one communications device associated with the registered user, the contact information optionally including a method for contacting the at least one communications device.

4. The system of claim 1, further comprising a simulator program having at least one of a mobile and an online interface, the simulator program designed to train the user on how to use the system.

5. The system of claim 1, wherein the system is administered by at least one of a pharmaceutical company, a managed care organization, a PBM, a pharmacy chain, a disease management company, a healthcare marketing agency, and a technology firm.

6. A method implemented using a processor and a database for inputting and accessing a patient log by a user, the method comprising:
receiving from the user at least one open-ended electronic message;
storing the patient log in the database;
converting the at least one open-ended electronic message from the user into a log entry for the patient log using the processor;
managing the patient log; and
displaying at least one of a message and the patient log to the user.

7. The method of claim 6, further comprising: receiving at least one open-ended electronic message from a communication device associated with the user or the patient log.

8. The method of claim 6, further comprising: parsing at least one open-ended electronic message by generating at least one token, performing syntax analysis on all tokens to form valid expressions, working out the implications of the expression just validated and taking an appropriate action.

9. The method of claim 8, wherein parsing the at least one open-ended electronic message generates a log entry that includes two or more patient events, wherein each of the two or more patient events is information directly input by the user.

10. The method of claim 8, wherein parsing the at least one open-ended electronic message excludes entries that can be generated by only one valid message made of a single user input to generate a log entry.

11. The method of claim 8, further comprising the use of keywords or commands by the user to report to or manage the patient log.

12. The method of claim 11, wherein the keywords or commands are predefined and relate to at least one of the events that the user is reporting and the action that the user is triggering.

13. The method of claim 8, further comprising receiving from the user a plurality of open-ended electronic messages related to a single log entry with instructions to report such entry.

14. The method of claim 13, further comprising a parsing process that requires at least two incoming messages and provides instructions to the user on how to report in at least one outgoing system message.

15. The method of claim 8, where the parsing is done using at least one of a vectorial approach and a neural network.

16. The method of claim 8, wherein tokens are expressed through different combinations of characters.

17. The method of claim 8, wherein the appropriate action associated with the allowable expression is at least one of updating the log, generating a log entry, sending one or more messages to the communications device requesting additional information or clarification about ambiguities in prior messages, configuring alerts to be sent to the communications device at times determinable by the expression, sending at least one confirmation message to the communication device of certain actions performed by the system, including updating the log, setting default values for at least one log entry in case such values are omitted, setting default values to trigger actions related to managing the log, attaching an image or multimedia record to a log entry, and providing help to the user, providing the capability of viewing, editing or deleting a previous entry, and considering the rest of the message as a valid string and, without analyzing its content further, storing it in the right field of the system database.

18. The method of claim 8, wherein the appropriate action associated with the allowable expression is sending one or more messages to the communications device requesting additional information or clarification about ambiguities in prior messages and further comprising receiving the additional information and using at least one of the information and the additional information to complete a valid expression and translating the valid expression into an action, wherein the action includes at least one of updating one or more fields in the patient log and managing the patient log.

19. The method of claim 8, wherein the appropriate action associated with the allowable expression is configuring alerts to be sent to the communications device at times determinable by the expression, and wherein the alerts are meant to prompt the user to perform an action related to at least one of managing the log and educating the user.

20. The method of claim 19, further comprising, transmitting the alerts to the communication device associated with the registered user according to the information associated with the alerts.

21. The method of claim 8, further comprising:
determining whether the user has alerts set up to prompt the user to perform an action related to managing the log; and
based on the outcome, sending or not sending at least one message to the communications device to help the user configure alerts related to such actions.

22. The method of claim 21, wherein the action is to report to the system to generate a log entry.

23. The method of claim 8, further comprising training the user on how to use the system using a simulator with at least one of mobile and online interfaces.

24. The method of claim 8, further comprising:
querying the user regarding administration of at least one of medication and disease symptoms;
sending the user reminders with instructions to report;
sending messages to clarify in case of ambiguity;
sending confirmation messages after a full entry is made in the log;
setting default values for a log entry; and
allowing the user to set up a schedule of reminders.

25. The method of claim 8, wherein the log is used for care of a patient having a disease or disorder.

26. The method of claim 25, wherein the disease or disorder is hemophilia.

27. The method of claim 25, wherein the disease or disorder is at least one of rheumatoid arthritis, diabetes, cancer, chronic pain, asthma, erectile dysfunction, heart disease, stroke, an autoimmune disease, transplant rejection, an HIV disease, Parkinson's disease, or Alzheimer's disease.

28. The method of claim 8, wherein the data exchanged relates to at least one of administration of medication, wellness, prevention, healthcare education, reinforcement, dietary activities, and disease symptoms.

29. The method of claim 8, further comprising querying the user regarding at least one of administration of medication and disease symptoms.

30. The method of claim 8, further comprising an alternative interface to at least one of complete the log, access the log and perform all actions allowed by such interface, and wherein the interface is at least one of the Internet, interactive voice response, and a software application compatible with the system.
